(19) United States
(12) Patent Application Publication
(10) Pub. No.: US 2006/0102649 A1
(43) Pub. Date: May 18, 2006

(54) Good Cup

(76) Inventor: Grigor Garukyan, Glendale, CA (US)

Correspondence Address: Grigor Garukyan, 2520 Berkeley Avenue, Los Angeles, CA, 90926, US

(21) Appl. No.: 10/957,902

(22) Filed: Oct. 5, 2004

(51) Int. Cl. G07F 11/00

(52) U.S. Cl. 221/288

(57) ABSTRACT

A basket for removing pills from a vial is disclosed. The basket serves as a trap for at least one pill raising the level of the pill, and therefore, making removal of the pill from a vial easier. The basket can be made in a variety of sizes and shapes as well as using many materials. The basket is placed in an ordinary vial and by closing the lid, turning the vial approximately 180 degrees, then turning it back to its right side up position, one can use the Good Cup. The Good Cup is recommended for the elderly especially for people with arthritis in their hands. Overall the Good Cup makes taking medication from a vial easier, safer, more convenient, and more sanitary than conventional methods.

### CROSS-REFERENCE TO RELATED APPLICATIONS

This non-provisional application is related to the provisional application filed on Aug. 21, 2003, application No. 60/496,545.

### STATEMENT REGARDING FEDERALLY SPONSORED RESEARCH OR DEVELOPMENT

Not Applicable

### BACKGROUND OF THE INVENTION

This invention is technically related to devices that catch or prevent some of the similar items from falling. These devises are used in automated machines, conveyer systems, labeling machines, packaging, and electromechanical mechanisms.

### BRIEF SUMMERY OF THE INVENTION

The Good Cup (GC) consists of a basket placed in a standard pharmaceutical vial. The concave body of the basket consists of a thin spherical arm, which widens into a concave capturing surface (pill plate). When the GC is turned upside down the pills gather near the lid. When it is turned to its right side up position the pills go back to the bottom of the vial, but either one or a few pills stay on the capering surface. The pills can be removed from the basket by opening the lid of the vial. The GS makes removing pills from a vial easier, faster, safer (prevents spills), and more sanitary.

### BRIEF DESCRIPTION OF THE SEVERAL VIES OF THE DRAWINGS

The invention will be described in more detail using references to the appended drawings.

FIG. 1 depicts, an assembly view of the standard pill filled vial, the lid of the vial and the basket.

FIG. 2 depicts, an assembly view of the basket set into the vial, the lid of the vial, and the magnified detailed view of the wall of the GC.

FIG. 3 depicts, an assembly view of the GC before turning.

FIG. 4 depicts, an assembly view of the GC upside down, but before it is shaken.

FIG. 5 depicts, an assembly view of the GC shaken, turned right side up and the lid removed.

FIG. 6 depicts, a view of the basket.

FIG. 7 depicts, an assembly of the basket and the pill in their normal projections with sections and their isometric view.

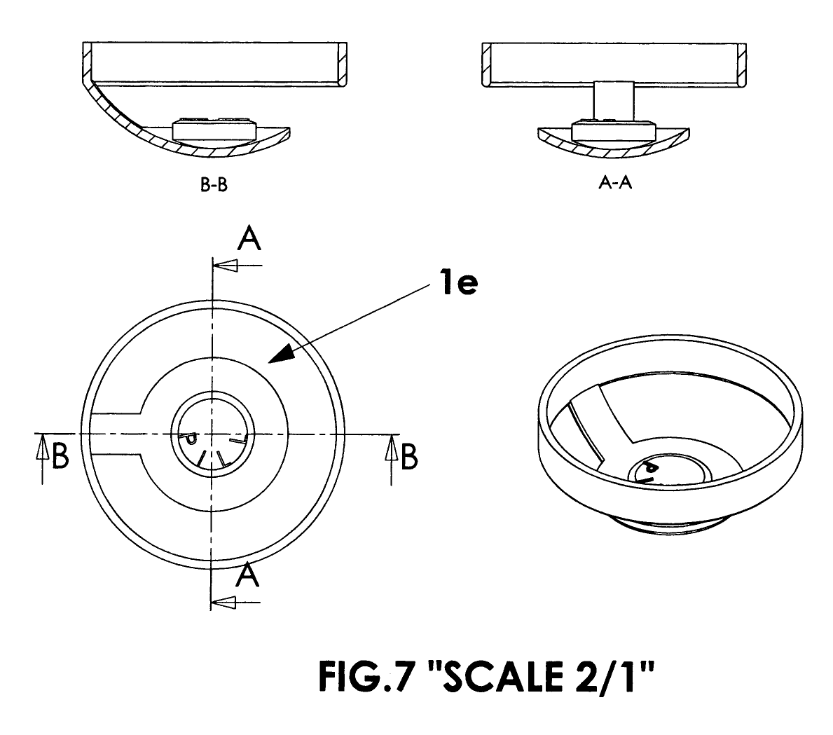

### DETAILED DESCRIPTION OF THE INVENTION

The GC consists of a standard pharmaceutical vials (with standard lids), and plastic baskets, which can be made by injection molding. The appropriate size baskets are chosen for appropriate size vials. The GC can also be made using many different types of materials. The GC can be used in hospitals, clinics, homes and many other environments. The advantage of the GC is that it supplies the medication to the patient easily, comfortably, safely, and sanitarily then conventional methods.

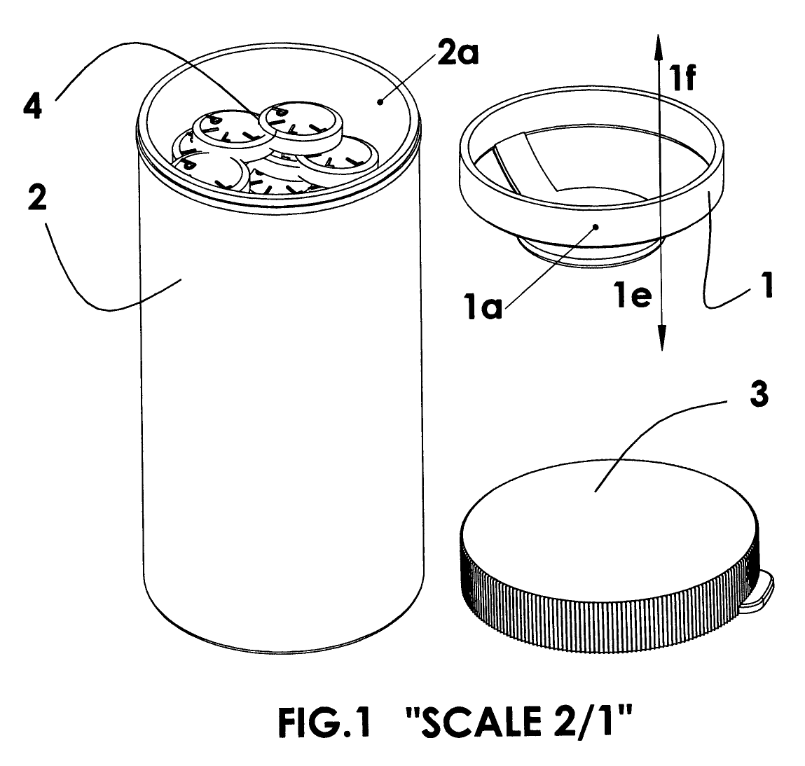

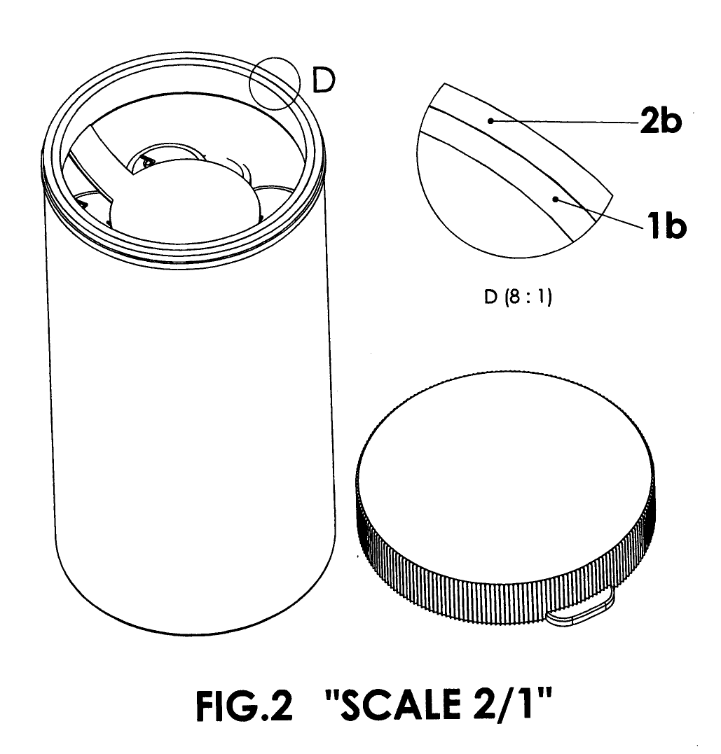

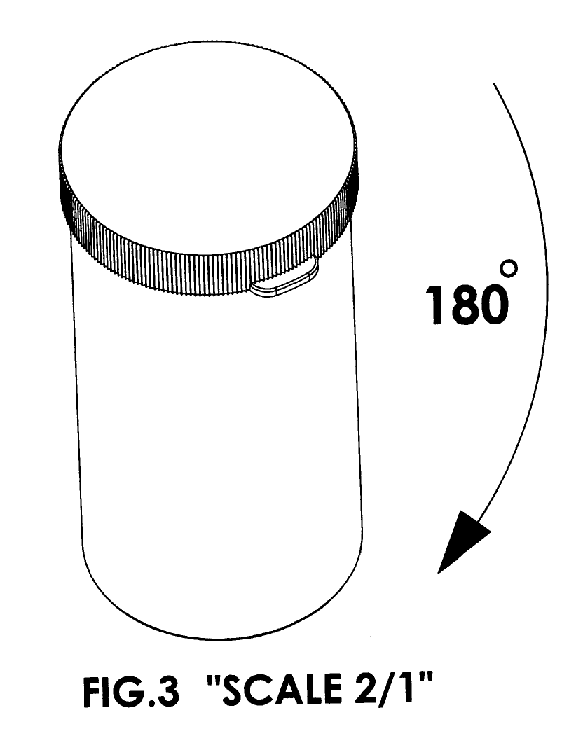

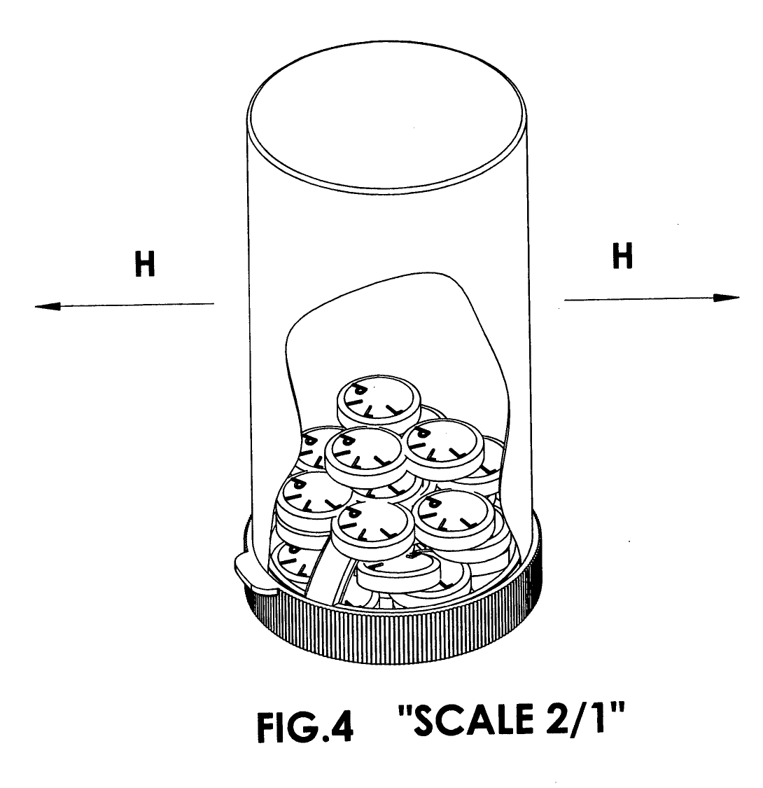

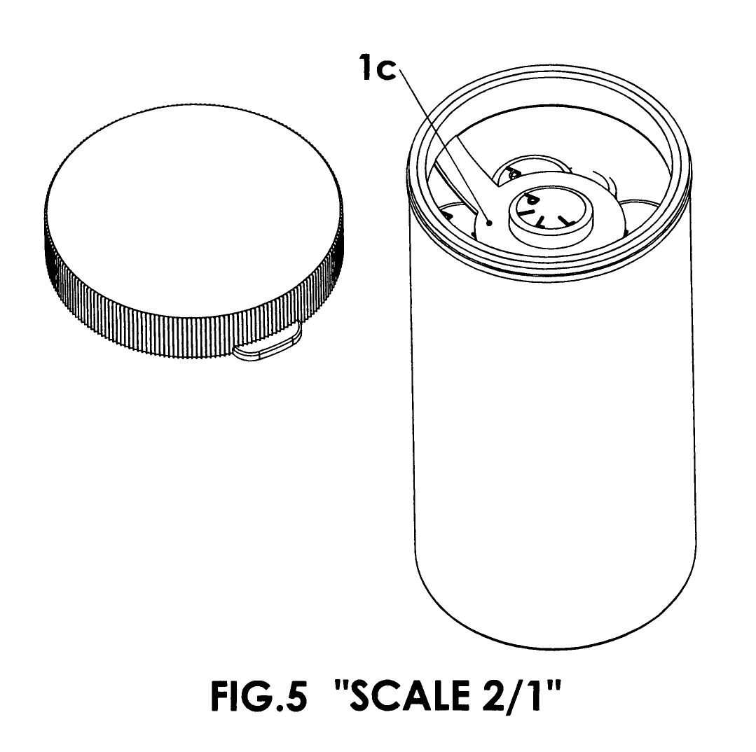

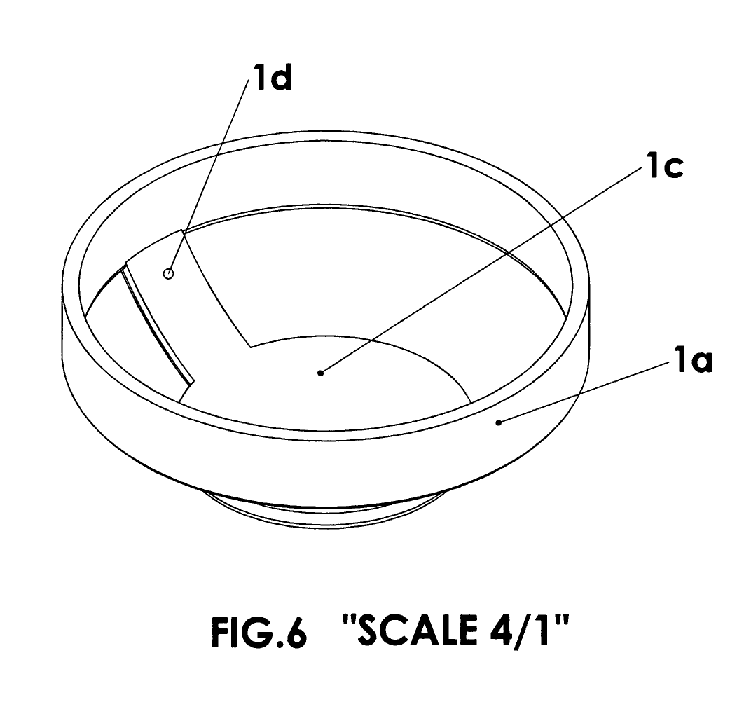

The following part will use the drawings to explain the invention in detail. The GC consist of a standard vial FIG. 1-2, filled with pills FIG. 1-4, a basket FIG. 1-1, and a standard lid FIG. 1-3. To assemble the GC the basket is set into the vial such that that the outer wall of the basket FIG. 1-1a comes into contact with the inner wall of the vial FIG. 1-2a (from the top of the vial). The basket is set into the vial by locational clearance fitting such that the top of the round wall of the vial FIG. 2-2b and the top of the round wall of the basket FIG. 2-1b are at the same level. The lid can be placed on top of the vial and the GC is ready for use. When the GC is turned upside down (approximately 180 degrees) FIG. 3, the pills fall near the lid from the inside, the GC is then shaken side to side FIG. 4-hh one to two times, at this time some of the pills assume a vertical position and fall through the C shaped window FIG. 1-1e in the FIG. 1-1f direction. The pills then gather on the inside surface of the lid FIG. 4. When the good cup is brought to its right side up position FIG. 3, most of the pills return to the bottom of the vial through the C shaped window. When the lid is removed at least one pill remains on the capturing surface of the basket FIG. 5-1c, FIG. 6-1c. Altering the size of the capturing surface of the basket FIG. 5-1c, FIG. 6-1c, or changing the size of the arm of the basket FIG. 6-1d can change the desired pill amount. These alterations control the probability of the number of pills that fall through C shaped window FIG. 1-1e. When the pill(s) is in the basket, it can be removed from the capturing surface FIG. 5-1c. If necessary the capturing surface can be made with multiple cavities. In addition, if the medication is a capsule, then the capturing surface must to be oval. By closing the lid the whole process can be repeated.

When the number of pills reduces to one to three pills it is recommended that the user extract the pills using conventional methods. The method of extraction utilized by the GC can also be used to extract many other small objects from containers with ease. For Example, small nails, nuts, screws etc. . . . This method can also be used to extract a certain amount of powder or liquid from a container. For example, this method makes the measurement of dosage easier and faster. In these situation the basket is made in such a way so that it is easily removable.

I claim:

1. The Good Cup, consisting of an assembly of already manufactured standard vials with their lids, and to be manufactured baskets made of different sizes and materials; by turning it upside down, shaking (making the pills fall through the C shaped window), turning it right side up (at least on pill remains in the capturing surface which can have many or one cavities and of different sizes and shapes), and opening the lid, it is possible to safely, easily, conveniently, and sanitarily take the pill from the basket, which is set in the top of the vial.

2. The C shaped window, through which the pills fall, on the basket of the Good Cup in claim 1, can be in different shapes and sizes.

3. The basket of the Good Cup in claim 1 is set at the top of the vial with locational clearance fitting so that the concave surface of the capturing surface faces the inside surface of the lid and it doesn't interfere with the function of the lid.

4. The basket of the Good Cup in claim 1 is set so the top horizontal circular wall of the basket is leveled with the top horizontal circular wall of the vial.

5. The capturing surface of the basket of the Good Cup in claim 1 can have many cavities.

6. The capturing surface of the basket of the Good Cup in claim 1 can be spherical, conical, and cylindrical.

7. The C shaped window of the basket of the Good Cup in claim 1 can be in different shapes and sizes to control the amount of pills falling and remaining on the capturing surface.

8. In claim 1, when the Good Cup is turned approximately 180 degrees and shaken one to two times, some of the pills, which become vertically oriented, fall through the C shaped window to the hole inside surface of the lid.

9. In claim 1, when the Good Cup is turned right side up and the lid is removed, at least one pill remains on the capturing surface of the basket.

10. The Good Cup can perform other functions, such as extracting a set amount of liquid or powder from a container.

11. The Good Cup, which performs different functions in claim 10, has baskets that are easy to empty (in this case the flow of liquids or powder needs to be temporarily stopped either from the container/vial), or the basket needs to be removable.
